(19) United States
(12) Patent Application Publication
(10) Pub. No.: US 2002/0091902 A1
(43) Pub. Date: Jul. 11, 2002

(54) File system and data caching method thereof

(76) Inventor: Susumu Hirofuji, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 09/931,917

(22) Filed: Aug. 20, 2001

(30) Foreign Application Priority Data
Jan. 10, 2001 (JP) 2001-002412

(51) Int. Cl. G06F 13/00

(52) U.S. Cl. 711/133

(57) ABSTRACT

A file system composed of a computer having a host interface driver, a disk array system, and a cache memory, the file system that can improve the prediction accuracy to a data access request and the use efficiency of the cache memory, and can speed up a response to the request.

### CROSS-REFERENCE TO RELATED APPLICATIONS

This application is based upon and claims the benefit of priority from the prior Japanese Patent Application No. 2001-2421, filed on Jan. 10, 2001; the entire contents of which are incorporated herein by reference.

### FIELD OF THE INVENTION

The present invention relates to a file system composed of an information processor and an auxiliary memory, and a data caching method of the system. The present invention, more particularly, relates to a file system having an auxiliary memory capable of rapidly responding to a data access request from an information processor, and a data caching method of the system.

### BACKGROUND

Generally, in an information processor, e.g. a computer, which is used for a file system, the process of data transfer between the information processor and an auxiliary memory, e.g. a disk array unit, is performed via a bus according to a procedure prescribed in small computer system interface (SCSI) or FC, which are standardized by American national standards institute (ANSI).

However, the auxiliary memory can recognize neither meaning of each transfer data nor how to use the data on the computer because there is no need to consider them during the data transfer procedure.

On the other hand, there is a magnetic disk unit having a cache memory, which is accessed easier than a magnetic disk, in order to rapidly response to a data access (write or read) request from the computer. In this case, the cache memory is used for temporarily retaining not only read data but also data predicted to have high possibility of being accessed.

For example, when receiving a request for reading data, the system reads, in addition to the data, data stored in the neighborhood of the sectors where the data is stored, and retains it in the cache memory. The caching can reduce time required for an access to the auxiliary memory.

However, when a computer requests access to data not retained in the cache memory, the system must read the requested data from the magnetic disk. So improvement of the accuracy of the prediction is required.

Data to be read from or written into the auxiliary memory by a computer is stored as a file in a plurality of unit storage areas in each auxiliary memory (‘data sectors’ in the case of a magnetic disk). However, even data belonging to the same file is not always stored in a series of areas on a recording medium, for example, due to the position of data already stored in the auxiliary memory. That is, there is a case where one data file is divided into units having a fit size for the unit storage area, and is stored in a plurality of discontinuous storage areas.

The auxiliary memory having a cache memory can read, in advance, data stored in a series of unit storage areas, replying to a request for accessing a file from the computer. However, it is difficult to read, in advance, data stored in discontinuous unit storage areas.

Further, it is very difficult to predict the timing of access from the computer. If data stored in the auxiliary memory is copied into another memory to back up the data in inappropriate timing, there is some possibility that data inconsistency occurs on the file system.

### SUMMARY

In accordance with an embodiment of the present invention, there is provided a file system. The file system comprises a first memory to store files in units of data block, a second memory the access speed of which is faster than the first memory's, means for requesting to be provided with a file stored in the first memory, means for recognizing a file of which access frequency is higher than a predetermined value and data blocks composing the recognized file, and a controller which stores copy of a part or the whole of the composing data blocks in the second memory, and reads data blocks composing the requested file from the second memory at the request means' request if it is stored in the second memory or reads data blocks composing the requested file from the first memory if not.

Also in accordance with an embodiment of the present invention, there is provided a data caching method. The method comprises storing files in a first memory in units of data block, receiving a request to read a file stored in the first memory, recognizing a file of which access frequency is higher than a predetermined value, recognizing data blocks composing the recognized file, storing copy of a part or the whole of the composing data blocks in the second memory, the access speed of which is faster than the first memory's, determining whether the data blocks composing the requested file is stored in the second memory, and reading the composing data blocks from the second memory if it is stored in the second memory or from the first memory if not.

### BRIEF DESCRIPTION OF THE DRAWINGS

The accompanying drawings, which are incorporated in and constitute part of this specification, illustrate various embodiments and/or features of the invention and together with the description, serve to explain the principles of the invention. In the drawings:

FIG. 1 is a block diagram showing a main configuration of a filing system consistent with a first embodiment of the present invention;

FIG. 2 is a block diagram showing data transfer between a host computer and a disk array system consistent with the first embodiment;

FIG. 3 is a diagram showing an example of general file management by an operating system;

FIG. 4 is a diagram showing an example of file management in a UNIX system;

FIG. 5 is a diagram showing an example of file management in another file system;

FIG. 6 is a flowchart showing an example of a procedure for determining whether file accesses by a host interface driver are concentrated;

FIG. 7 is a flowchart showing an example of a procedure for determining whether a file should be closed due to access concentration;

FIG. 8 is a flowchart showing an example of operation of a disk array system consistent with the first embodiment;

FIG. 9 is a block diagram showing data transfer between a host computer and a disk array system consistent with a second embodiment of the present invention;

FIG. 10 is a flowchart showing an example of operation of a disk array system consistent with the second embodiment;

FIG. 11 is a diagram showing a constitutional change of the hard disk units consistent with the second embodiment;

FIG. 12 is a block diagram showing data transfer between a host computer and a disk array system consistent with a third embodiment of the present invention; and

FIG. 13 is a flowchart showing an example of operations of a disk array system and a host interface driver consistent with the third embodiment.

### DETAILED DESCRIPTION

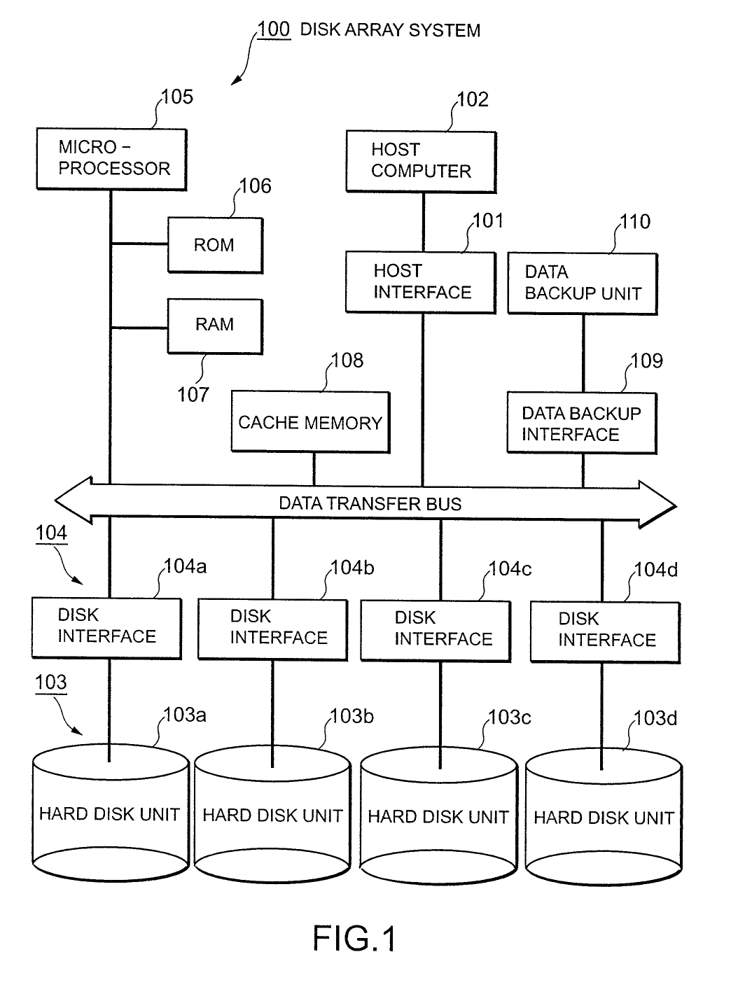

FIG. 1 is a block diagram showing a main configuration of a filing system consistent with a first embodiment of the present invention. A disk array system 100 is connected, at its internal host interface 101, to a host computer 102 via a data bus according to SCSI or FC, for example.

The disk array system 100 has a plurality of hard disk units 103, i.e., 103a, 103b, 103c, and 103d for storing data, which are connected to a data transfer bus respectively via disk interfaces 104, i.e., 104a, 104b, 104c, and 104d, such as SCSI buses.

Further, the disk array system 100 has a microprocessor 105 for controlling the whole system, a ROM 106 for storing various codes and variables, a RAM 107 which is a main memory, and a cache memory 108. The disk array system 100 performs the data transfer process between the disk array system 100 and the host computer 102.

The host interface 101, the disk interface 102, and the microprocessor 105 are mutually connected via a data transfer bus, such as a PCI bus. A data backup unit 110 may be connected to the data transfer bus via a data backup interface 109.

When the disk array system 100 receives a request for writing data, the request that is composed of a command and data, from the host computer 102, the command is transferred to the RAM 107 to be analyzed by the microprocessor 105, while the data is transferred to the cache memory 108. The data transferred to the cache memory 108 is divided according to the sector number of the hard disk units 103 and properly stored in the plurality of hard disk units 103.

On the other hand, when the disk array system 100 receives a request for reading data from the host computer 102, the command is transferred and analyzed by the RAM 107. As a result, desired data is read from the hard disk unit 103 and transferred to the cache memory 108.

Further, when predicting to receive a request for reading data stored in a sector continuous to the read sector, the disk array system 100 also reads the data stored in the continuous sector into the cache memory 108. The disk array system 100 transfers only the requested data to the host computer 102.

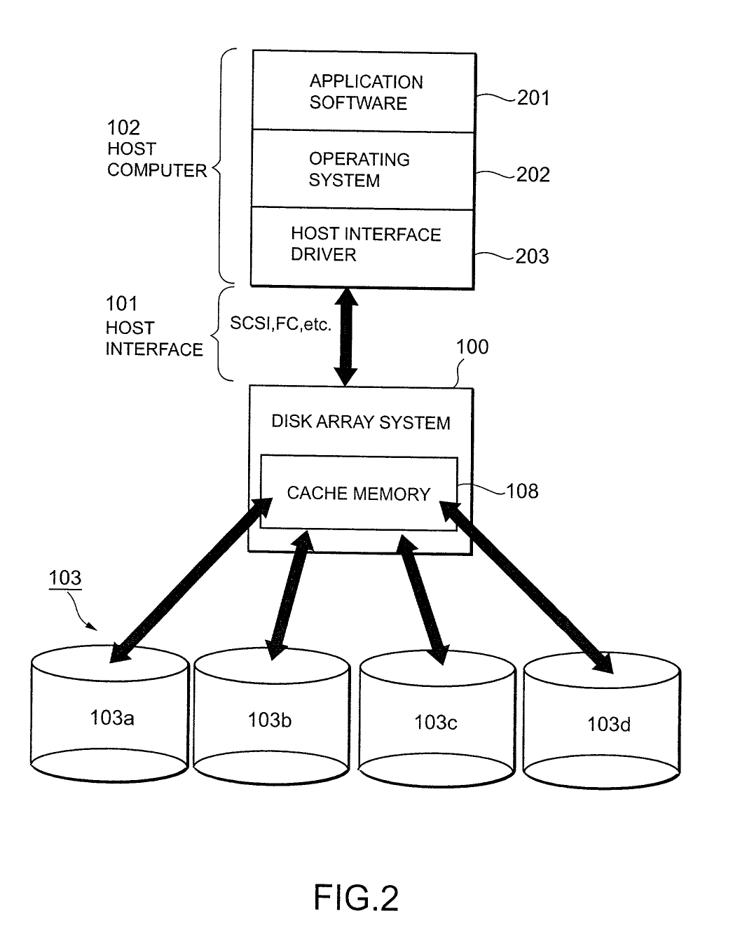

FIG. 2 is a block diagram showing data transfer between the disk array system 100 and the host computer 102. The host computer 102 includes application software 201, an operating system 202, and a host interface driver 203.

When a user requests to read a desired file stored in the disk array system 103 by means of the function of the application software 201, the operating system 202 recognizes the desired file, data block by data block, the file which may be divided and stored in the disk array system 103 by means of a file managing function according to an i-node (described later), and then transfers the request to the disk array system 100 via the host interface 101.

The host interface driver 203 takes statistics of the frequency of such a data access request from the application software 201, and, at the point of time when the frequency exceeds a preset reference value, recognizes a file to be a file of high access frequency. Hereafter, when access to this file of high access frequency occurs, namely, when the file is opened, the host interface driver 203 notifies the disk array system 100 of the related information, such as the sectors storing the file. When the application software 201 closes the file, the host interface driver 203 notifies the disk array system 100 of it and the disk array system 100 lowers the data's order of priority in the cache memory 108.

On the other hand, the disk array system 100 reads the data stored in a sector positioned in a predetermined neighborhood on the hard disk 103 into the cache memory 108 based on the information relating to the file received from the host interface driver 203. By doing this, the probability that data is read from the cache memory 108 replying to the next access request is increased. Further, when the disk array system 100 receives the file closing information from the host computer 102, the system lowers the order of priority of the data stored in the neighboring sector.

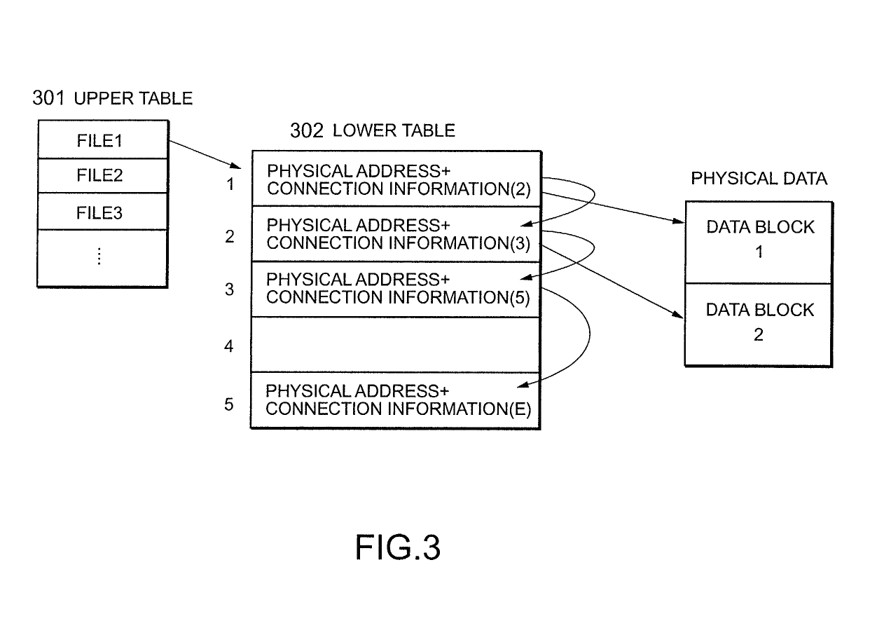

FIG. 3 is a diagram showing an example of general file management by an operating system 202. In an upper table 301, the top addresses in a lower table 302 are recorded with their several file names of files 1 through 3. In the lower table 302, physical addresses of data blocks stored in the disk array system 103 and the connection information regarding the data blocks belonging to the same file are stored.

That is, in the example shown in FIG. 3, the file 1 in the table 301 is divided into four data blocks, which are stored in the addresses indicated by addresses 1, 2, 3, and 5 in the table 302, and each actual data is stored in the corresponding disk array system 103. Therefore, every time a file is actually accessed, these two tables are referred to.

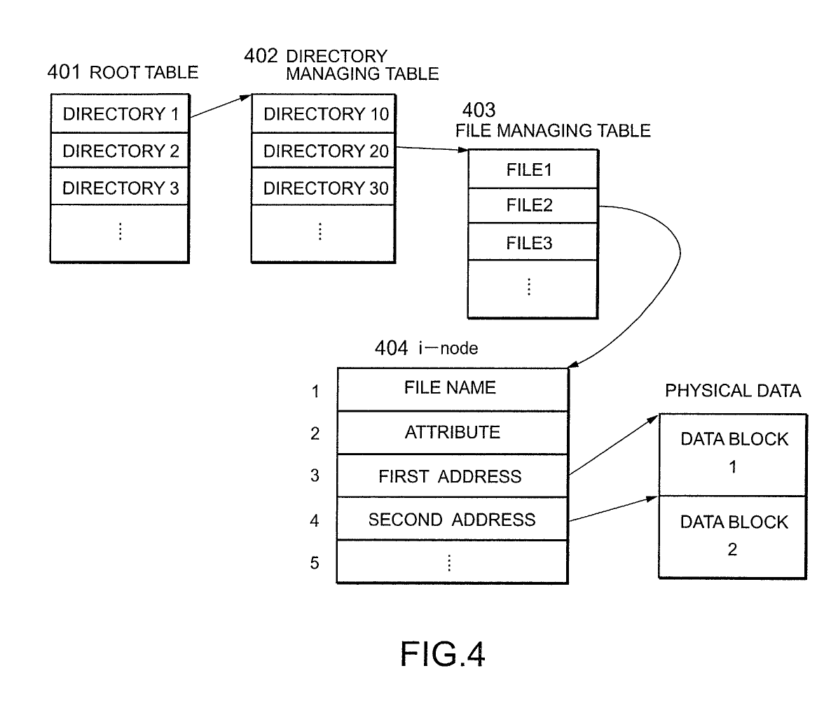

FIG. 4 is a diagram showing an example of file management in a UNIX system. In this case, each file is managed with a form of an i-node, and in response to an access request from the application software 201, the file system first searches for its i-node.

For example, when a file is designated in a form of ‘/directory1/directory20/file2’ from the application software 201, the directory 1 of the root table 401, the directory 20 of the directory managing table 402, and the file 2 of the file management table 403 are pursued up to the file 2, and finally the i-node 404 of the file 2 is obtained. In the i-node 404, a file attribute and addresses indicating storage positions of physical data belonging to the same file in the hard disk unit 103 are recorded with its file name.

The operating system 202 can interpret up to the i-node 404. When the operating system 202 designates the i-node 404, the disk array system 100 recognizes the storage positions of the data blocks 1 and 2 designated by the respective addresses. The host computer 102 holds the i-node that is file-opened once.

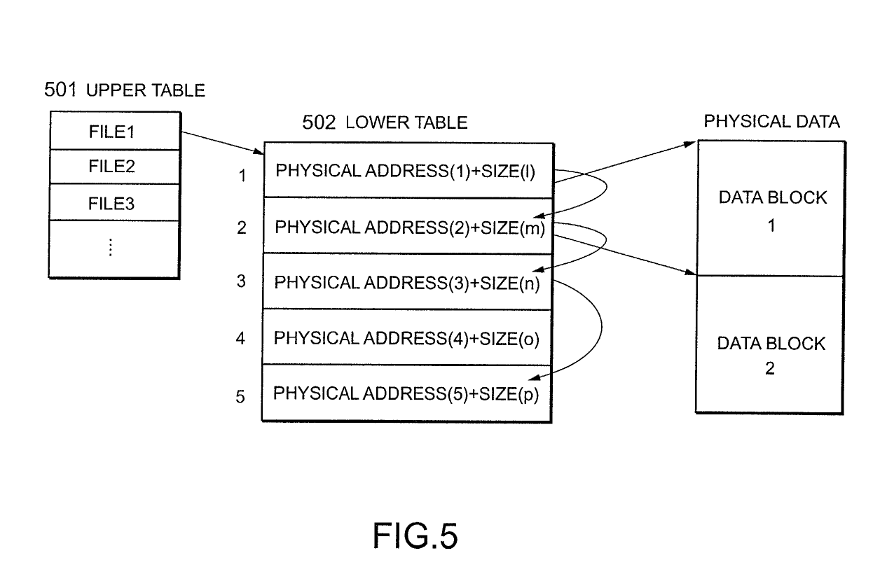

Further, as shown in FIG. 5, another type of file management may be adopted to this embodiment. In an upper table 501, a plurality of file names is stored. In a lower table 502, physical addresses storing data blocks in the hard disk unit 103 and the connection order of data blocks belonging to the same file are recorded. Further, the size of each data block may be also recorded with the physical address information. By doing this, a data management system considering data continuity can be realized.

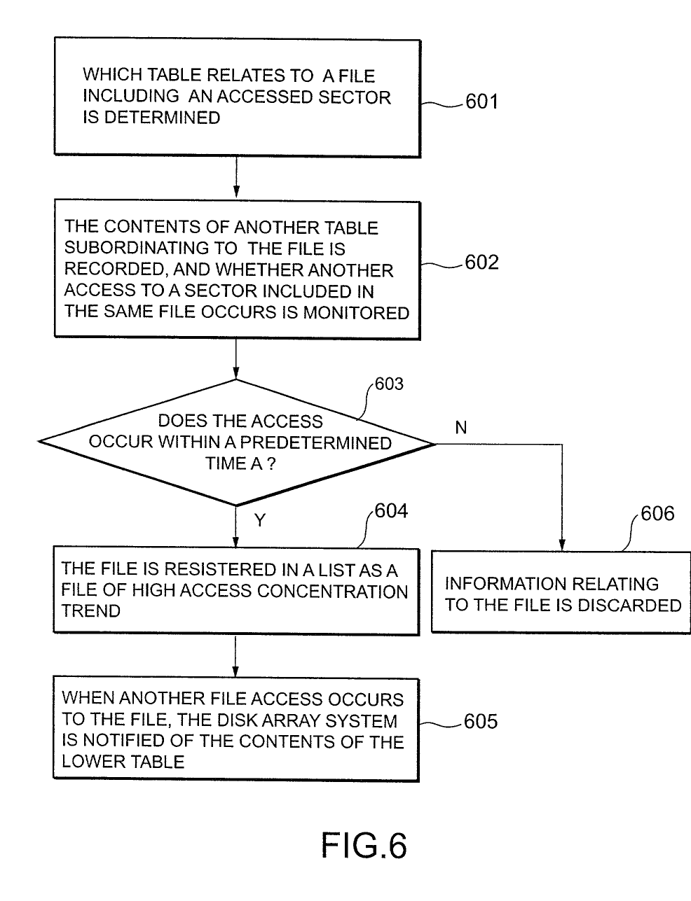

FIG. 6 is a flowchart showing an example of a procedure for determining whether file accesses by a host interface driver 103 are concentrated. Firstly, the host interface driver 103 determines which table (the upper table 301 in FIG. 3) relates to a file (the file 1 in FIG. 3) including a sector accessed by the application software 201 (601). Then the host interface driver 203 records the contents of another table (the lower table 302 in FIG. 3) subordinating to the file, and monitors whether another access from the application software 201 to a sector included in the same file occurs continuously within a predetermined time (time A in FIG. 6) (602).

When access to the file occurs within the time A (603) the host interface driver 203 registers the file in its own list as a file of high access concentration trend (604). Hereafter, when another file access occurs to the file, the host interface driver 203 notifies the disk array system 100 of the contents of the lower table 302 (605).

On the other hand, when access to the file does not occur within the time A (603), the host interface driver 203 discards the information relating to the file (606). A file access concentration notification command may be composed of a command code, a file identification number (a file name is also acceptable), and the table 302 recording a sector, and a size, etc.

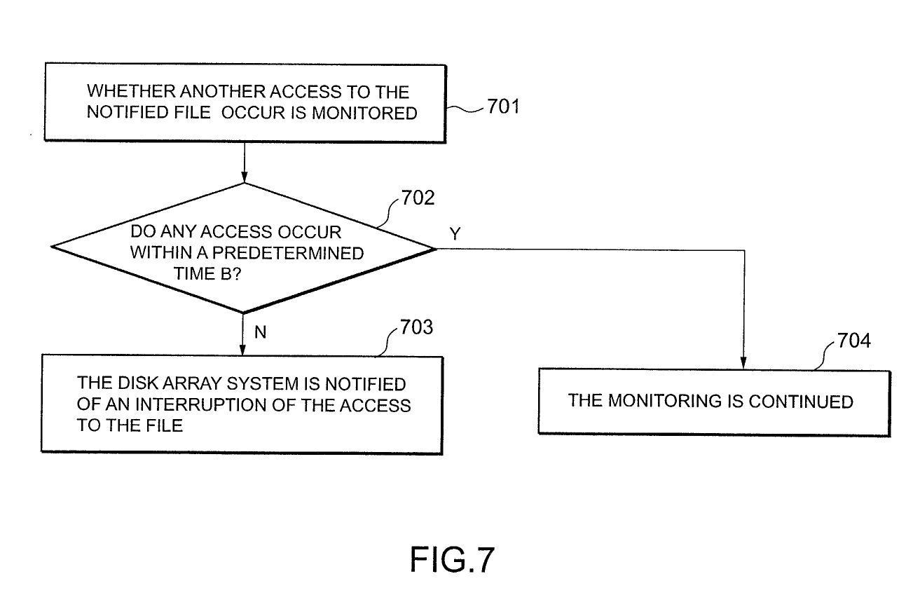

FIG. 7 is a flowchart showing an example of a procedure for determining whether a file should be closed due to access concentration. The host interface driver 203 monitors whether an access from the application software 201 to the file notified to disk array system 100 occurs continuously within a predetermined time (time B in FIG. 7) (701). When no access to the file occurs within the time B (702), the host interface driver 203 notifies the disk array system 100 of an interruption of the access to the file (703).

On the other hand, when there is access occurs within the time B, the host interface driver 203 continues the monitoring relating to the file. A file close notification command may be composed of a command code and a file identification number. A file name may be also acceptable for the file identification number.

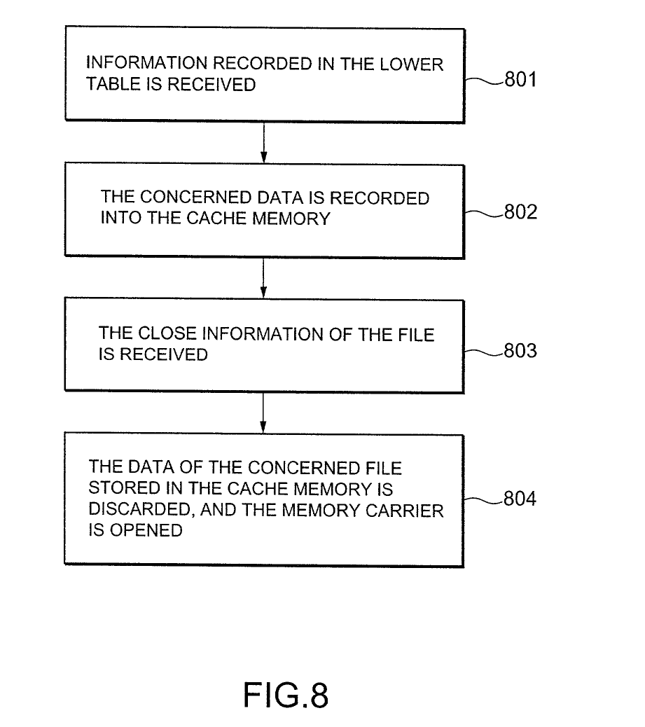

FIG. 8 is a flowchart showing an example of operation of a disk array system 100. The disk array system 100 receives information recorded in the lower table 302 from the host interface driver 201 by using a predetermined command (801). The disk array system 100 records the concerned data into the cache memory 108 according to the sector information of the table 302 (802).

The disk array system 100 receives the close information of the file by a predetermined command from the host interface driver 210 (803). The disk array system 100 discards the data of the concerned file stored in the cache memory 108 and opens the memory carrier (804).

The disk array system 100 takes statistics of the frequency of data access request by the body of the host computer 102. And the disk array system 100, at the point of time when the frequency exceeds a predetermined reference value, recognizes a file to be a file of high access frequency, and retains it in the cache memory 108 in priority. By doing this, the prediction accuracy for a data access request from the host computer 102 can be improved and the response time can be shortened.

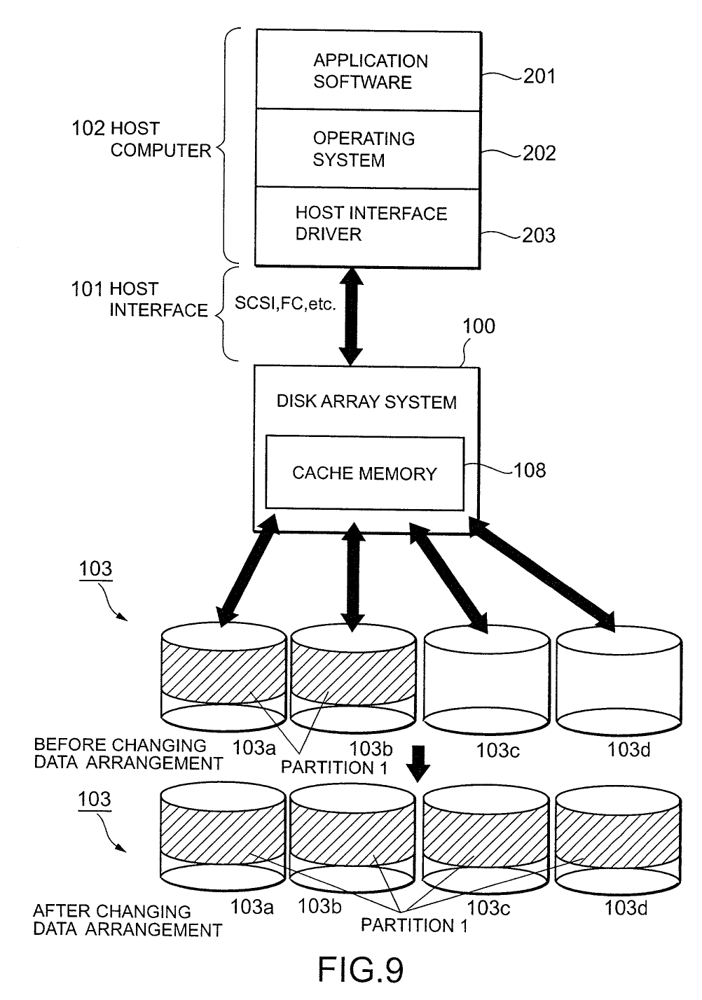

FIG. 9 is a block diagram showing data transfer between the host computer 102 and the disk array system 100 consistent with a second embodiment of the present invention. In this second embodiment, the host interface driver 203 takes statistics of the concentration degree of data access request from the application software 210 on the partition level. And the host interface driver 203, at the point of time when the concentration degree exceeds a predetermined reference value, recognizes a partition to be a partition of high access concentration degree, and notifies the disk array system 100 of the partition.

Each partition is a divided area on the hard disk. When many partitions having a small capacity are prepared, the size of a cluster, which is a minimum unit for reading and writing, can be made smaller. So the partition is used for increasing the use efficiency of the hard disk unit 103.

When the disk parallelism of the partition notified from the host computer 102 can be increased, the disk array system 100 changes the data arrangement to increase the disk parallelism, as shown in FIG. 9, so that the response time may be shorten.

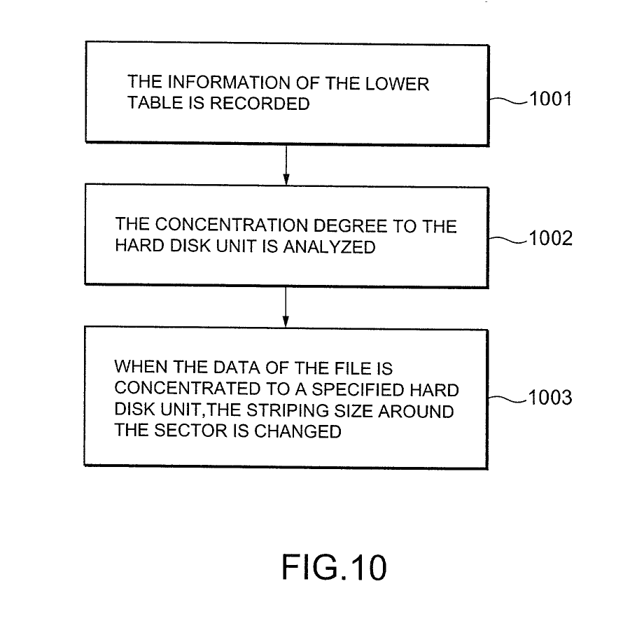

FIG. 10 is a flowchart showing an example of operation of a disk array system 100. In this case, the operation of the host interface driver 203 is the same as described above. Upon receipt of the information of the lower table 302 by means of a predetermined command from the host interface driver 203 (1001), the disk array system 100 analyzes the concentration degree to the hard disk unit 103 based on the sector information of the table 302 (1002).

As a result, when the data of the file is concentrated to a specified hard disk unit 103 beyond a predetermined reference value, the striping size around the sector is changed so that the data is dispersed in the hard disk unit 103 (1003).

There may be two methods for changing the constitution of the hard disk unit 103. (1) All the striping sizes in the disk array system 100 are changed. (2) The striping size only in a specified area in the disk array system 100 is changed and the area is separately recorded. And when receiving an access to this area, data is read from the hard disk unit 103 after being recognized the difference in the striping size. Because both of them can be performed online, the host computer 102 cannot recognize the sector to be changed in such cases.

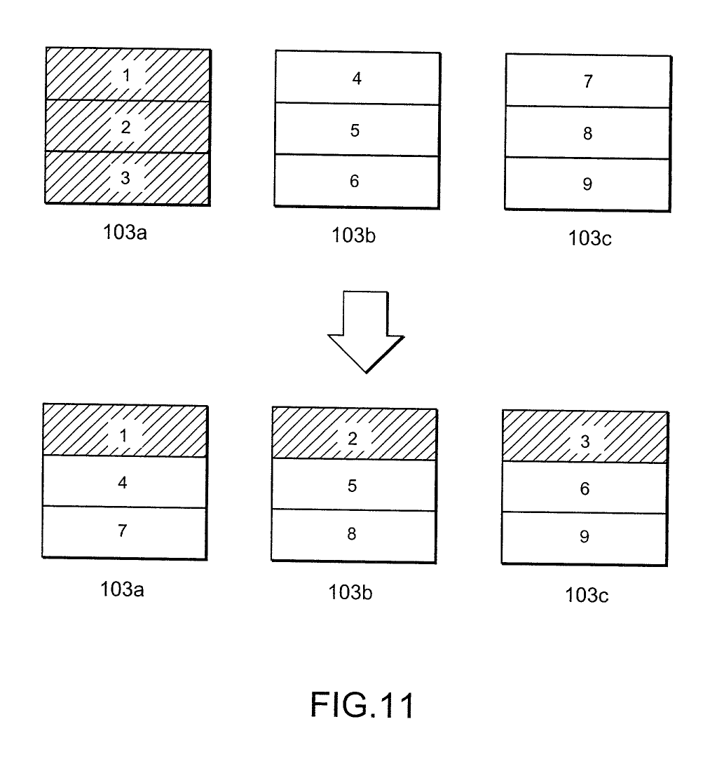

For example, the data in the concerned area may be saved in the cache memory 108 for a while and may be written back into the hard disk unit 103 after changing the striping size. When data 1, 2, and 3 concentrate in one hard disk unit 103a, for example, they may be respectively dispersed in the hard disk units 103a through 103c as shown in FIG. 11.

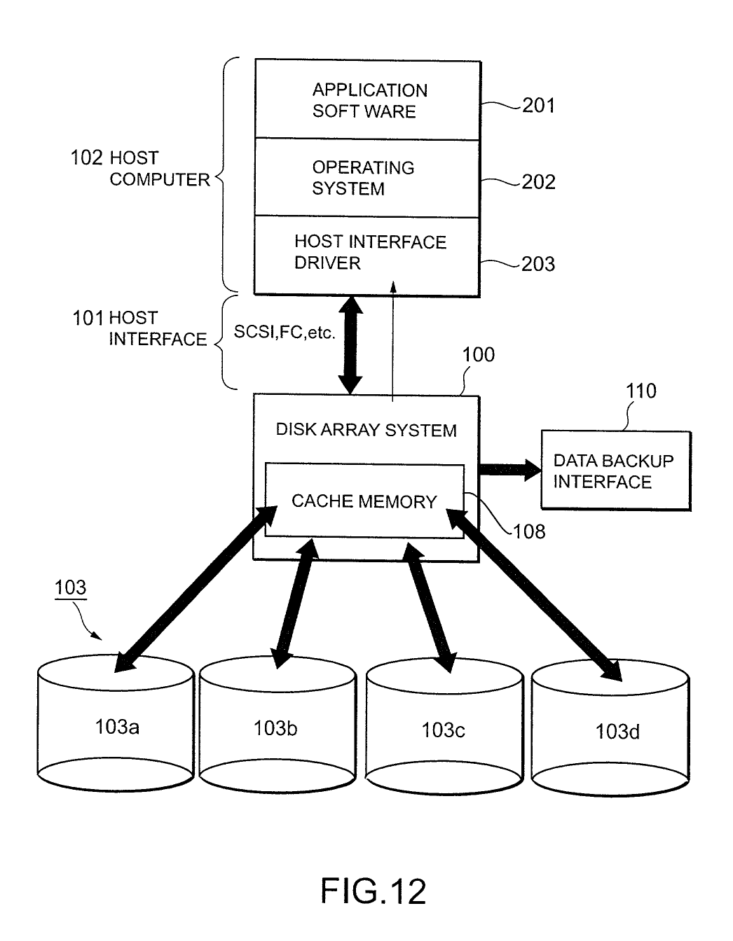

FIG. 12 is a block diagram showing data transfer between the host computer 102 and the disk array system 100 consistent with a second embodiment of the present invention. In this third embodiment, the host interface driver 203 notifies the disk array system 201 of the file information relating to the data to be written. On the other hand, when an update request of the corresponding file occurs during backup, the disk array system 100 receives it by the cache memory 108, backs up the corresponding file, and then writes it into the hard disk unit 103. Further, the disk array system 100 notifies the host computer 102 of that the corresponding data is under backup.

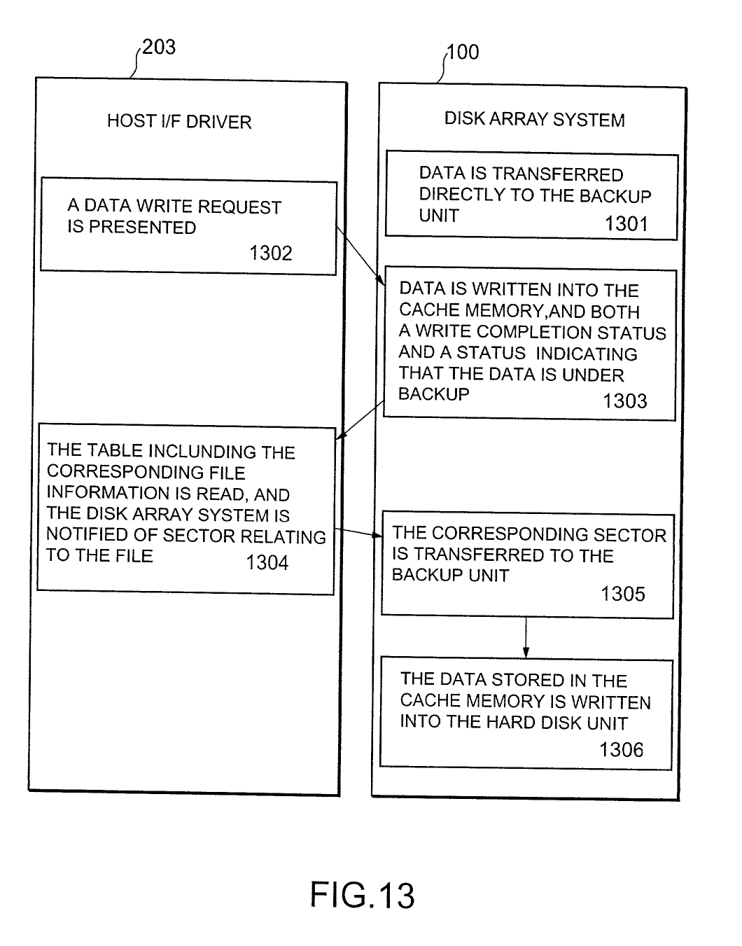

FIG. 13 is a flowchart showing an example of operations of a disk array system 100 and a host interface driver 203. When the host interface driver 203 presents a data write request (1302) while the disk array system 100 is transferring data directly to the backup unit 109 (1301), the disk array system 100 writes data to be written into the cache memory 108 once, and returns, to the host computer 102, both a status indicating completion of writing and a status indicating that the data is under backup (1303). Thereafter, the host interface driver 203 reads the table 302 including the corresponding file information, and notifies the disk array system 110 of sector relating to the file using a predetermined command (1304).

The sector of the corresponding file is ascertained from the file information received from the host interface driver 203. So, the disk array system 100 transfers the corresponding sector to the backup unit 110 (1305). After completion of data transfer to the backup unit 110, the disk array system 100 writes the data stored in the cache memory 108 into the hard disk unit 103 (1306).

By doing this, even if the hard disk unit 103 receives an update request for the data is presented from the host computer 102 during copying data from the hard disk unit 103 into another auxiliary memory, the possibility of occurrence of data inconsistency on the file system can be reduced.

Although not shown in the drawing, another following application example of the present invention may be considered as a fourth embodiment. Namely, when access is made to a file by a data access request from the application software 201, the host interface driver 203 determines, at a predetermined period, whether data stored in the file tends to be accessed sequentially like moving image data or to be accessed at random, and notifies the disk array system 100 of the file characteristic. Or, the host interface driver 203 may receive the information on the characteristic as a part of a request from the application software 201.

On the other hand, the disk array system 100 may determine the arrangement priority of data stored in the cache memory 108 according to information from the host computer 102, and uses the cache memory 108 effectively. For example, it is intended to prevent the cache memory 108 from remaining much data when the frequency of sequential access is relatively high, while data as much as possible is arranged in the cache memory 108 when the frequency of random access is high. Because data to be cached is selected according to the characteristic in terms of being used on the host computer 102, a rapid response is available to a data access request.

As described above in detail, both the prediction accuracy to a data access request from the computer and the use efficiency of the cache memory can be improved. Further, a response to an access request can be speeded up more. Even while data is being copied into another auxiliary memory, an update request for the data can be presented from the computer, and no data inconsistency occurs on the file system.

The present invention is explained by embodiments using the disk array system 100 for convenience. However, it is not necessarily the disk array system. Further, the cache memory 108 may be installed in the host computer 102.

What is claimed is:

1. A file system comprising:
a first memory to store files in units of data block;
a second memory the access speed of which is faster than the first memory's;
means for requesting to be provided with a file stored in the first memory;
means for recognizing a file of which access frequency is higher than a predetermined value and data blocks composing the recognized file; and
a controller which stores copy of a part or the whole of the composing data blocks in the second memory, and reads data blocks composing the requested file from the second memory at the request means' request if it is stored in the second memory or reads data blocks composing the requested file from the first memory if not.

2. The system of claim 1, wherein:
the recognizing means detects a close of the recognized file and notifies the controller of the close; and
the controller lowers the copy's order of priority in the second memory when receiving the notification.

3. The system of claim 1, wherein:
the recognizing means detects a close of the recognized file and notifies the controller of the close; and
the controller deletes the copy from the second memory when receiving the notification.

4. The system of claim 1, wherein:
the first memory is a hard disk; and
the second memory is a cache memory.

5. The system of claim 1, wherein:
The file system, wherein:
the first memory is a plurality of hard disks each of which has a plurality of partitions;
the second memory is a cache memory;
the recognizing means recognizes a partition of which access frequency is higher than a predetermined value; and
the controller changes the data arrangement in the hard disks to increase the disk parallelism.

6. The system of claim 5, wherein:
the controller changes all the striping size in the hard disks to increase the disk parallelism.

7. The system of claim 1, wherein:
the recognizing means recognizes the higher access frequency file based on whether the file is accessed within a predetermined time of a former access.

8. The system of claim 7, wherein:
the recognizing means detects the file close based on whether the recognized file is not accessed within a predetermined time of a former access.

9. The system of claim 1, wherein:
the recognizing means determines for each file whether data blocks composing the file tends to be sequentially accessed or randomly accessed, and notifies the controller of the result; and
the controller allows more data blocks to be stored in the second memory when the file tends to be randomly accessed than when it tends to be sequentially accessed.

10. A data caching method, comprising:
storing files in a first memory in units of data block;
receiving a request to read a file stored in the first memory;
recognizing a file of which access frequency is higher than a predetermined value;
recognizing data blocks composing the recognized file;
storing copy of a part or the whole of the composing data blocks in the second memory, the access speed of which is faster than the first memory's;
determining whether the data blocks composing the requested file is stored in the second memory; and
reading the composing data blocks from the second memory if it is stored in the second memory or from the first memory if not.

11. The method of claim 10, further comprising:
detecting a close of the recognized file; and
lowering the copy's order of priority in the second memory when the close is detected.

12. The method of claim 10, further comprising:
detecting a close of the recognized file; and
deleting the copy from the second memory when the close is detected.

13. The method of claim 10, wherein:
the first memory is a hard disk; and
the second memory is a cache memory.

14. The method of claim 10, wherein:
the first memory is a plurality of hard disks each of which has a plurality of partitions;
the second memory is a cache memory; the method, further comprising:
recognizing a partition of which access frequency is higher than a predetermined value; and
changing the data arrangement in the hard disks to increase the disk parallelism.

15. The method of claim 14, wherein:
the changing includes changing all the striping size in the hard disks to increase the disk parallelism.

16. The method of claim 10, further comprising:
recognizing the higher access frequency file based on whether the file is accessed within a predetermined time of a former access.

17. The method of claim 16, further comprising:
detecting the file close based on whether the recognized file is not accessed within a predetermined time of a former access.

18. The method of claim 10, further comprising:
determining for each file whether data blocks composing the file tends to be sequentially accessed or randomly accessed; and
allowing more data blocks to be stored in the second memory when the file tends to be randomly accessed than when it tends to be sequentially accessed.
